(19) United States
(12) Patent Application Publication
(10) Pub. No.: US 2026/0005483 A1
(43) Pub. Date: Jan. 1, 2026

(54) RING LASER WITH THERMALLY STABLE INTRACAVITY FREQUENCY-COMB GENERATION

(71) Applicant: THE REGENTS OF THE UNIVERSITY OF COLORADO, A BODY CORPORATE, Denver, CO (US)

(72) Inventors: Shu-Wei HUANG, Boulder, CO (US); Mingming NIE, Boulder, CO (US)

(21) Appl. No.: 18/638,451

(22) Filed: Apr. 17, 2024

Related U.S. Application Data
(60) Provisional application No. 63/459,914, filed on Apr. 17, 2023.

(51) Int. Cl. H01S 3/08; H01S 3/04; H01S 3/067; H01S 3/10; H01S 3/30

(52) U.S. Cl. CPC H01S 3/08013; H01S 3/0405; H01S 3/0675; H01S 3/06791; H01S 3/10061; H01S 3/302

(57) ABSTRACT

A ring laser includes an optical amplifier, a birefringent resonator, a polarizing beamsplitter, and a bandpass filter forming a ring cavity. The resonator has a first series of resonances corresponding to a first linear polarization and a second series of resonances corresponding to a second linear polarization orthogonal to the first linear polarization. The ring laser generates intracavity pump light having the first linear polarization. The resonator generates stimulated Brillouin laser (SBL) light in response to the pump light coupling to a first resonance of the first series of resonances, the SBL light having the second linear polarization. The resonator generates dissipative Kerr solitons in response to the SBL light coupling to a second resonance of the second series of resonances, the dissipative Kerr solitons having the second linear polarization. The solitons form a frequency comb that is coupled out of the ring cavity via the polarizing beamsplitter.

### RELATED APPLICATIONS

This application claims priority to U.S. Provisional Patent Application No. 63/459,914, filed Apr. 17, 2023, the entirety of which is incorporated by reference herein.

### STATEMENT REGARDING FEDERALLY SPONSORED RESEARCH OR DEVELOPMENT

This invention was made with government support under grant number DE-REB029541 awarded by the National Institutes of Health, and grant number ECCS2048202 awarded by the National Science Foundation. The government has certain rights in the invention.

### BACKGROUND

The dissipative-Kerr-soliton (DKS) frequency comb, generated by pumping an ultrahigh-quality-factor resonator, has been a ground-breaking technology with a remarkable breadth of demonstrated applications [1, 2]. Among other benefits, DKS frequency combs provide access to large comb spacings in nonconventional spectral ranges, thereby enabling high-capacity communication with high spectral efficiency [3, 4], ultrafast optical ranging with massive parallelism [5], and high-speed spectroscopy in the molecular-fingerprinting region [6].

### SUMMARY

The present embodiments include a ring laser that lases to generate a single-frequency intracavity pump that, in turn, provides the energy for intracavity generation of stimulated Brillouin lasing (SBL) light. In turn, the SBL light provides the energy for intracavity generation of a dissipative-Kerr-soliton (DKS) frequency comb. Because the DKS frequency comb is generated using SBL light, it is also referred to herein as a Brillouin-DKS frequency comb. The ring laser uses a birefringent resonator to both (i) filter the pump light and (ii) serve as a nonlinear optical medium for both converting the pump light into SBL light and converting the SBL light into the DKS frequency comb. The ring laser offers several benefits that are not attainable with prior-art DKS microcombs that are generated outside of a laser cavity. These benefits include phase insensitivity, self-healing behavior, deterministic selection of the DKS state, and access to the ultralow-noise comb state. The Brillouin-DKS frequency comb may be implemented with various platforms (e.g., fiber-based and photonic integrated circuits) to create a user-friendly (e.g., turnkey operation) and field-deployable comb source. Having ultralow timing jitter, the Brillouin-DKS frequency comb is particularly useful as a photonic flywheel.

In embodiments, a ring laser includes an optical amplifier, a birefringent resonator, a polarizing beamsplitter, and a bandpass filter forming a ring cavity. The birefringent resonator has a first series of resonances and a second series of resonances, the first series of resonances corresponding to a first linear polarization, the second series of resonances corresponding to a second linear polarization that is orthogonal to the first linear polarization. The polarizing beamsplitter has a first output port and a second output port, the first output port being configured to transmit intracavity light having the first linear polarization into the ring cavity, the second output port being configured to transmit intracavity light having the second linear polarization out of the ring cavity. The ring laser is configured to generate intracavity pump light having the first linear polarization. The birefringent resonator is configured to generate stimulated Brillouin laser (SBL) light in response to the intracavity pump light coupling to a first resonance of the first series of resonances, the SBL light having the second linear polarization. The birefringent resonator is configured to generate a dissipative-Kerr-soliton (DKS) frequency comb in response to the SBL light coupling to a second resonance of the second series of resonances, the DKS frequency comb having the second linear polarization.

### BRIEF DESCRIPTION OF THE FIGURES

FIG. 1A is a schematic diagram of a ring laser that implements thermally stable intracavity frequency-comb generation, in embodiments.

FIG. 1B shows two images of a multimode-fiber Fabry-Perot microresonator that may be used with the ring laser of FIG. 1A, in embodiments.

FIG. 1C shows frequency-calibrated transmission and reflection spectra of a pump mode of the multimode-fiber Fabry-Perot microresonator of FIG. 1B.

FIG. 1D is a measured optical spectrum of a frequency comb outputted by the ring laser of FIG. 1A.

FIG. 1E is a radio-frequency (RF) beat note of a stimulated Brillouin scattering (SBS) frequency shift.

FIG. 2A is a phase-space plot of stimulated Brillouin lasing (SBL) detuning versus pump detuning that illustrates an attractor for the thermally stable generation of a dissipative Kerr soliton (DKS) frequency comb with the ring laser of FIG. 1A.

FIG. 2B is plot of pump frequency shift versus time during turn-on of the ring laser of FIG. 1A.

FIG. 2C is a plot of frequency-comb power versus time during turn-on of the ring laser of FIG. 1A.

FIG. 2D is a plot of pump Pound-Drever-Hall (PDH) signal versus time during turn-on of the ring laser of FIG. 1A.

FIG. 3A illustrates ten consecutive turn-on switching tests performed with the ring laser of FIG. 1A.

FIG. 3B shows plots of turnkey success probability versus fine tuning of the microresonator cavity length (top) and coarse tuning of the microresonator cavity length (bottom).

FIG. 3C shows the optical spectra of a single-soliton state (top), a perfect soliton crystal (PSC) state with two solitons (middle), and a PSC state with three solitons (bottom).

FIG. 4A are plots illustrating soliton self-healing from instantaneous perturbations to the microresonator cavity length.

FIG. 4B are plots illustrating soliton immunity to slow modulation of the microresonator cavity length.

FIG. 5A is a plot of single-sideband (SSB) frequency noise of the single-frequency pump, the SBL, and one of the Brillouin-DKS comb lines.

FIG. 5B is a plot of relative intensity noise (RIN) of the 980-nm pump, single-frequency pump, SBL, and SBL soliton.

FIG. 5C is a plot of SSB phase noise of the SBS frequency shift and the SBL soliton repetition rate.

FIG. 5D are plots of the comb power (top) and soliton repetition rate (bottom), as measured over two hours in a laboratory environment.

FIG. 6 shows one example of how the multimode-fiber Fabry-Perot microresonator of FIG. 1B may be temperature controlled and mechanically stressed, in embodiments.

FIG. 7 is a perspective view of a photonic integrated circuit that is one example of a chip-based embodiment of the ring laser of FIG. 1A.

### DETAILED DESCRIPTION

In the time domain, dissipative-Kerr-soliton (DKS) timing jitter is the key property that determines its applicability as an optical flywheel [7-9], where the pristine temporal periodicity and sub-optical-cycle timing jitter can be utilized for demanding applications at the intersection of ultrafast optics and microwave electronics. Such applications include, but are not limited to, photonic analog-to-digital converters (ADCs) for radar and communication systems [10-12]; ultrafast sub-nanometer-precision displacement measurement for real-time probing of optomechanics, ultrasonics, and cell-generated forces [13, 14]; coherent waveform synthesizers for femtosecond and attosecond science [15-17]; and timing distribution links for large-scale scientific facilities like X-ray free-electron lasers and intense laser beamline facilities (e.g., the Extreme Light Infrastructure) [18-22].

Sub-optical-cycle and sub-femtosecond timing jitter have been theoretically predicted to be the quantum limit of DKS timing jitter [23]. However, due to excessive technical noise, this quantum limit was not experimentally demonstrated until a two-step pumping scheme was developed to mitigate pump-to-comb noise conversion and lower DKS timing jitter towards the quantum limit [8]. This two-step pumping scheme utilizes the Brillouin effect [8, 9, 24-26] to enable free-running photonic flywheels in various platforms, including monolithic fiber-optic-based Fabry-Perot (FP) cavities [8, 9], silica disk resonators and silica wedge resonators [25]. For example, a recent demonstration of a Brillouin-DKS frequency comb with a monolithic fiber FP cavity used this two-step pumping scheme to achieve a fundamental comb linewidth of 400 mHz and DKS timing jitter of 1 fs for averaging times up to 83 μs [9].

Recent demonstrations of turnkey, DKS-microcomb operation have eliminated complex comb-initiation dynamics and the need for sophisticated feedback electronics. Nevertheless, these prior-art turnkey DKS microcombs rely on nonlinear self-injection locking (NSIL), which is vulnerable to feedback phase fluctuations. Such phase sensitivity prevents NSIL-based microcombs from being user-friendly since careful configuration of their elements and components is necessary, and therefore not environmentally rugged. More importantly, the large timing jitter achieved with NSIL-based DKS microcombs prohibits their use as photonic flywheels for demanding applications (e.g., ultrafast optics, microwave electronics, etc.).

The present embodiments solve these problems by using the laser-cavity-soliton principle to facilitate turnkey comb-initiation dynamics. Specifically, the present embodiments combine the aforementioned two-step pumping scheme and an active gain medium within one laser ring cavity to decouple pump generation from comb generation. The laser ring cavity, in conjunction with this pump-comb decoupling (as achieved with the two-step pumping scheme), distinguishes the present embodiments from NSIL-based devices, leading to phase-insensitive turnkey operation with deterministic DKS states.

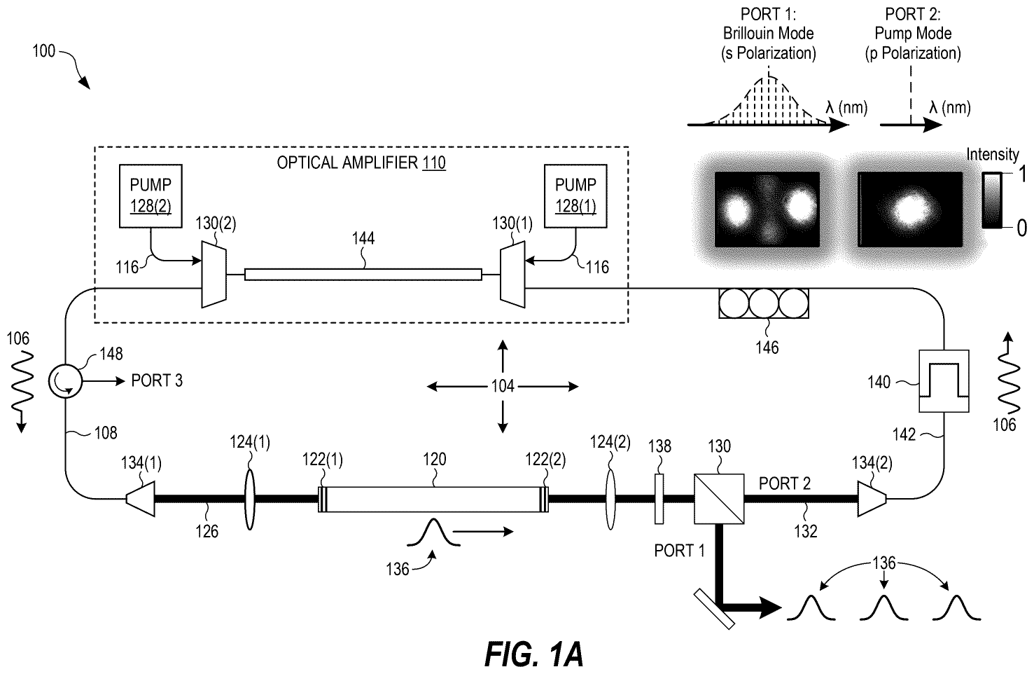

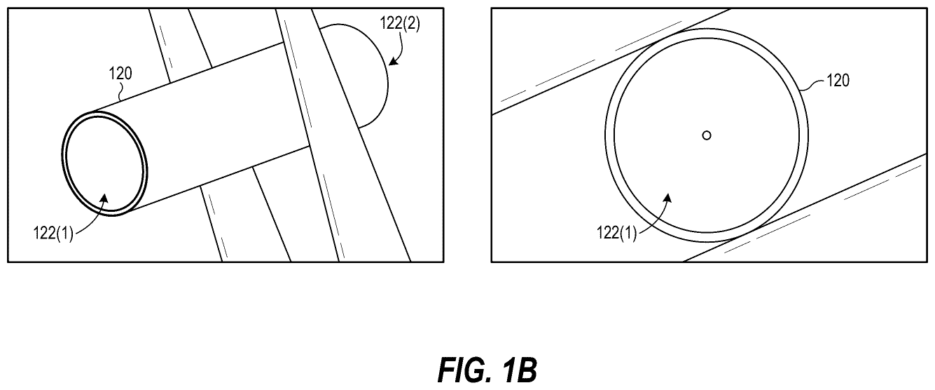

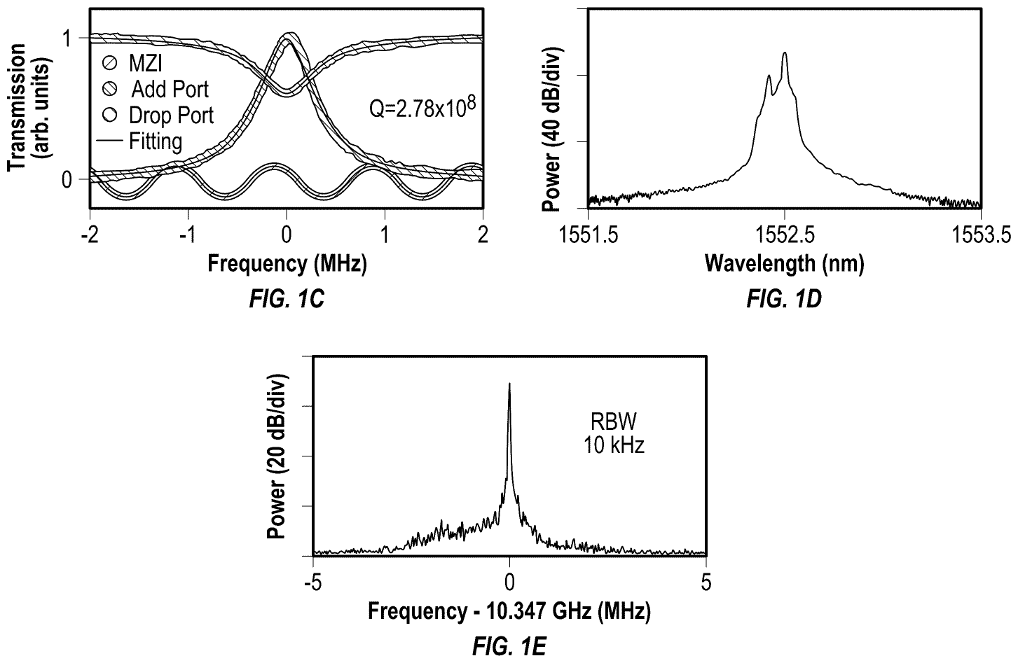

FIG. 1A is a schematic diagram of a ring laser 100 that implements thermally stable intracavity frequency-comb generation, in accordance with the present embodiments. The ring laser 100 includes an optical amplifier 110, a birefringent resonator 120, a polarizing beamsplitter 130, and an optical bandpass filter 140 that form a ring cavity 104. The ring cavity 104 is also referred to herein as a Chimera cavity to emphasize that the ring laser has two different cavities: the larger active ring cavity 104 and the shorter, passive, nonlinear resonator 120.

The birefringent resonator 120 forms a first series of optical resonances, or longitudinal modes, that correspond to a first linear polarization (e.g., p-polarized). The birefringent resonator 120 also forms a second series of optical resonances, or longitudinal modes, that correspond to a second linear polarization that is orthogonal to the first linear polarization (e.g., s-polarized). The ring laser 100 uses a first resonance of the first series of optical resonances for pump lasing, i.e., to generate intracavity pump light 106 that circulates around the ring cavity 104 in the counter-clockwise direction (with respect to the top-down view shown in FIG. 1A). This first resonance is also referred to as the pump resonance or pump mode. The ring laser 100 uses a second resonance of the second series of optical resonances for stimulated Brillouin lasing (SBL), i.e., to generate coherent SBL light. This second resonance is also referred to herein as the Brillouin resonance or Brillouin mode. The birefringent resonator 120 then converts some of the SBL light into dissipative Kerr solitons, i.e., an optical frequency comb. At the top right in FIG. 1A are spectra and beam profiles measured at Port 1 and Port 2 (i.e., the two outputs of the polarizing beamsplitter 130), where λ is wavelength.

Thus, the birefringent resonator 120 serves two roles in the ring laser 100. First, the resonator 120 acts as a high-finesse etalon filter that helps the ring laser 100 lase in a single pump mode with low frequency noise. For this reason, the ring laser 100 is also referred to herein as a microresonator-filtered laser. Second, the resonator 120 acts as an intracavity nonlinear optical medium used to generate the SBL light and dissipative Kerr solitons.

As shown in FIG. 1A, the birefringent resonator 120 may be a Fabry-Perot (FP) cavity formed from a first dielectric (Bragg) mirror 122(1) and a second dielectric mirror 122(2) that face each other to establish the first and second series of optical resonances. Since pump light is converted into SBL light within the resonator 120, it is preferable that the optical medium between the dielectric mirrors 122(1) and 122(2) include, either entirely or in part, a solid material. Examples of the solid material include amorphous solids (e.g., glass, fused silica, etc.), crystalline solids (e.g., quartz, sapphire, etc.), and plastics. The dielectric mirrors 122(1) and 122(2) may be deposited directly onto a single piece of the solid material, in which case the resonator 120 is monolithic. However, the resonator 120 may alternatively be non-monolithic. In embodiments, the birefringent resonator 120 has a free spectral range (FSR) of 1 GHz or more.

Since the resonator 120 is birefringent, the first and second series of optical resonances are not aligned with each other in frequency. Specifically, each first resonance of the first series of optical resonances is matched to a respective second resonance of the second series of optical resonances in that the first and second resonances have the same longitudinal mode number (i.e., the same integer number of half-wavelengths extending between the dielectric mirrors 122(1) and 122(2)). However, the first and second resonances have different frequencies because the resonator 120 has different refractive indices along the two polarization directions.

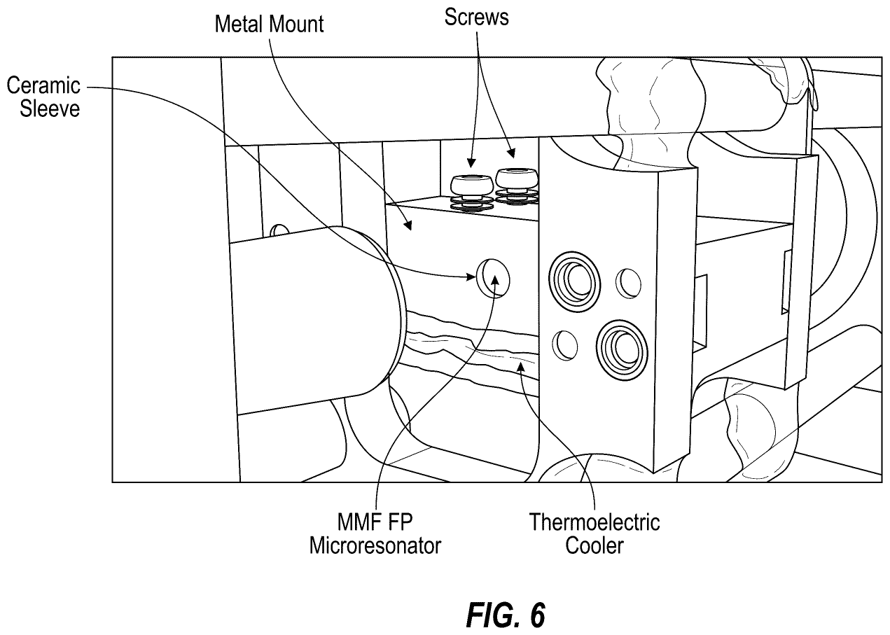

By changing the birefringence of the resonator 120, the frequency offset between the first and second resonances can be controlled. One way to control the birefringence is by stressing the resonator 120, e.g., via a piezoelectric element or an adjustable contact (e.g., a screw) that physically contacts a side of the resonator 120 (see FIG. 6). Another way to control birefringence is via temperature. Here, the different refractive indices may have different temperature dependencies. Another way to control birefringence is electrooptically. In this case, one or both of the different refractive indices of the optical medium may be controlled by applying an electric field across the crystal. Note that the resonator 120 may be constructed from an anisotropic material that is inherently birefringent (e.g., sapphire, quartz, etc.). Alternatively, the resonator 120 may be constructed from an isotropic material that is stressed, shaped, or otherwise configured to be birefringent. One example of the optical medium in this case is polarization-maintaining fiber, in which an isotropic material (e.g., fused silica) is stressed with rods to create two distinct polarization modes with different phase velocities.

In the experimental demonstration described below, the birefringent resonator 120 was constructed from a segment of graded-index multimode fiber (MMF) onto whose ends dielectric coatings were deposited to create the dielectric mirrors 122(1) and 122(2). In this case, the resonator 120 is also referred to herein as a MMF FP microresonator. The resonator 120 may alternatively be constructed from a segment of step-index multimode fiber. As an alternative to MMF, the resonator 120 may be constructed a segment of single-mode fiber. Other types of optical fiber that may be used for the resonator 120 include, but are not limited to, polarization-maintaining fiber, air-silica microstructure fiber, photonic crystal fiber, highly nonlinear fiber, large mode-area fiber, and doped fiber. As an alternative to optical fiber, the resonator 120 may be constructed from a bulk optic, a bulk photonic crystal, or a photonic metamaterial. The resonator 120 may be constructed from two or more different types of optical components (e.g., a combination of a bulk optic and a segment of optical fiber).

Additional components may be used to couple light into and out of the birefringent resonator 120. For example, FIG. 1A shows how the resonator 120 may be implemented via free-space coupling. Specifically, a first fiber coupler 134(1) couples pump light 106 from an optical fiber 108 into a collimated free-space pump beam 126. A first lens 124(1) couples the pump beam 126 into the resonator 120 via the first dielectric mirror 122(1). The first lens 124(1) is used for mode-matching the pump beam 126 to the resonator 120. A free-space pump beam 132 that couples out of the resonator 120 via the second dielectric mirror 122(2) is collimated by a second lens 124(2). After the pump beam 132 passes through the polarizing beamsplitter 130, a second fiber coupler 134(2) couples the pump beam 132 into an optical fiber 142. When the resonator 120 is constructed from a single-mode optical fiber or optical waveguide, the resonator 120 may be directly coupled to the optical fibers 108 and 142 without the fiber couplers 134(1) and 134(2) and lenses 124(1) and 124(2).

SBL light inside the birefringent resonator 120 generates dissipative Kerr solitons 136. The dissipative Kerr solitons 136 have the same linear polarization as the SBL light (i.e., orthogonal to the polarization of the pump light 106). The polarizing beamsplitter 130 is oriented to couple both the dissipative Kerr solitons 136 and SBL light out of the ring cavity 104 (see PORT 1 in FIG. 1A) as a pulse-train whose repetition rate is determined by the round-trip propagation time of the resonator 120. Spectrally, the dissipative Kerr solitons 136 form an optical frequency comb, also referred to as a microcomb. The ring laser 100 may include a polarization rotator 138 (e.g., a half waveplate) to rotate the polarization of the pump light 106 (i.e., the pump beam 132) such that the pump light 106 is transmitted through the polarizing beamsplitter 130, and to rotate the polarization of the dissipative Kerr solitons 136 such that the dissipative Kerr solitons 136 are reflected by the polarizing beamsplitter 130.

Energy for the pump light 106 is obtained from the optical amplifier 110, which is shown in FIG. 1A as a fiber amplifier. In this example, the optical amplifier 110 includes a doped fiber 144 as the gain medium, and one or both of a copropagating pump source 128(1) and a counterpropagating pump source 128(2). A first wavelength division multiplexer 130(1) combines the intracavity pump light 106 with amplifier pump light 116 from the copropagating pump source 128(1). The combined intracavity pump light 106 and amplifier pump light 116 is then coupled into the doped fiber 144. A second wavelength division multiplexer 130(2) couples amplifier pump light 116 from the counterpropagating pump source 128(2) into the doped fiber 144. While FIG. 1A shows the optical amplifier 110 operating with both counterpropagating and copropagating pump light 116, the optical amplifier 110 may alternatively operate with only counterpropagating pump light 116 or only copropagating pump light 116.

The doped fiber 144 may be doped with erbium, ytterbium, thulium, praseodymium, neodymium, or another dopant. In the experimental demonstration described below, the optical amplifier 110 was an erbium-doped fiber amplifier (EDFA). In this case, the pumps 128(1) and 128(2) are high-power laser diodes that emit at 980 nm and the intracavity pump light 106 is at 1550 nm. As an alternative to a fiber amplifier, the optical amplifier 110 may be a semiconductor-based amplifier (e.g., a semiconductor tapered amplifier) or an optical amplifier that uses a bulk optic (e.g., a crystal) as the gain medium.

The optical amplifier 110 may be polarization-maintaining. In this case, to properly align the polarization of the intracavity pump light 106 being amplified, the ring laser 100 may further include a polarization controller 146 prior to the optical amplifier 110. Examples of the polarization controller 146 include, but are not limited to, a fiber-paddle polarization controller and a combination of a rotatable half waveplate and a rotatable quarter waveplate. Alternatively, the optical amplifier 110 may be non-polarization-maintaining.

The optical bandpass filter 140 ensures that the ring laser 100 lases in only one mode of the ring cavity 104, i.e., that the intracavity pump light 106 is single-frequency. In some embodiments, the optical bandpass filter 140 has a bandwidth that is less than the FSR of the birefringent resonator 120, which may help ensure that only one mode of the ring cavity 104 is used for generating the intracavity pump light 106. The optical bandpass filter 140 may be constructed, for example, from a thin-film-coated interference filter or etalon.

The ring laser 100 may further include a circulator 148 to help ensure that the intracavity pump light 106 circulates in the counter-clockwise direction (i.e., to prevent the ring laser 100 from lasing in the clockwise direction). In the example of FIG. 1A, the circulator 148 has an output port (PORT 3) that may be used to monitor the intracavity pump light 106. As an alternative to the circulator 148, an optical isolator may be used.

### Experimental Demonstration

FIG. 1B shows two images of a MMF FP microresonator that was used as the birefringent resonator 120 of FIG. 1A. The MMF FP microresonator was made of graded-index multimode fiber (GRIN-MMF). FIG. 1C shows frequency-calibrated transmission and reflection spectra of a pump mode (i.e., a fundamental transverse mode) of the MMF FP microresonator shown in FIG. 1B. FIG. 1C shows that the linewidth, Q, and FSR of the MMF FP microresonator were measured to be 695 kHz, 2.78×10⁸, and 10.087 GHz, respectively. The data in FIG. 1C was measured using a Mach-Zehnder interferometer (MZI) that is described in more detail below (see section titled “Measurement of Laser Phase Noise and Fundamental Linewidth”). In FIG. 1C, “Add Port” refers to the input face of the MMF FP microresonator (i.e., the first dielectric mirror 122(1)) while “Drop Port” refers to the output face of the MMF FP microresonator (i.e., the second dielectric mirror 122(2)).

The active ring cavity, which included single-mode fiber, had a FSR of 26.8 MHZ, much larger than the microresonator linewidth. The BPF had a bandwidth of 8.5 GHZ, which is less than the microresonator FSR. This arrangement ensured single-frequency laser oscillation in the active ring cavity. The single-frequency pump light 106 was coupled into the fundamental traverse mode of the MMF FP microresonator for intermodal excitation of cross-polarized SBL (see FIGS. 1D and 1E) that in turn generates the DKS microcomb through the aforementioned two-step pumping scheme [8, 9]. As shown in FIG. 1A, the single-frequency pump and the cross-polarized SBL may be separated by the polarizing beamsplitter 130.

### Principle of Turnkey Brillouin-DKS Comb Generation

In the two-step pumping scheme, as the pump frequency is swept from the blue-detuned side of a pump resonance of the microresonator toward the center of the pump resonance, SBL light is first excited and then grows to generate a Brillouin-DKS frequency comb. If the offset frequency between the center of the pump resonance and the center of a Brillouin resonance of the microresonator is slightly larger than the SBS frequency shift, then the blue-detuned pump light and red-detuned SBL light can simultaneously exist in the microresonator. The opposite thermal nonlinearities of the pump and Brillouin resonances compensate each other, rendering the Brillouin-DKS comb generation thermally stable and accessible within an expanded existence range. Here, the pump-generating active ring cavity keeps the pump frequency near, but still blue-detuned from, the center of the pump resonance as the pump lasing will self-organize to the minimum loss and the maximum gain [39].

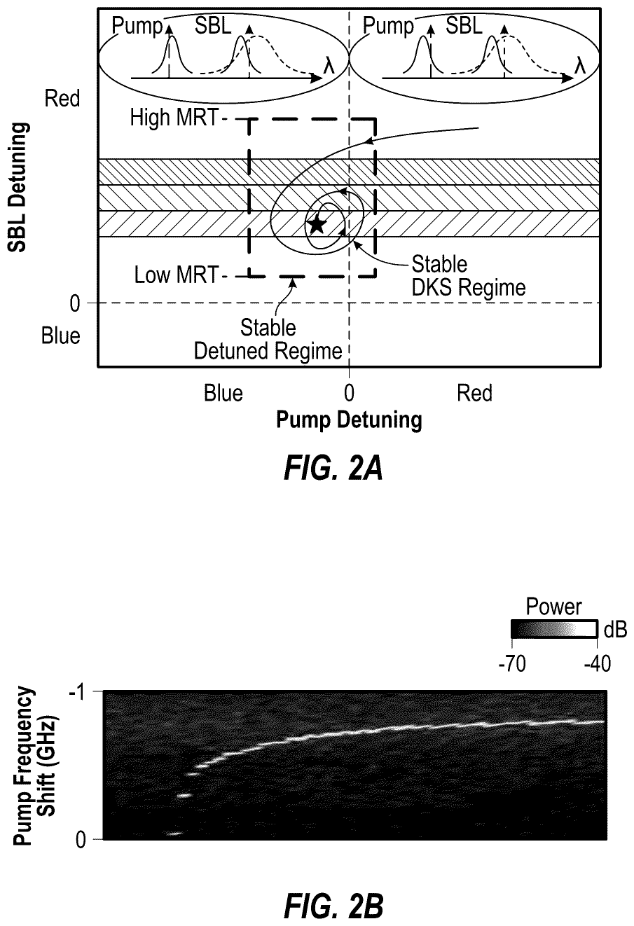

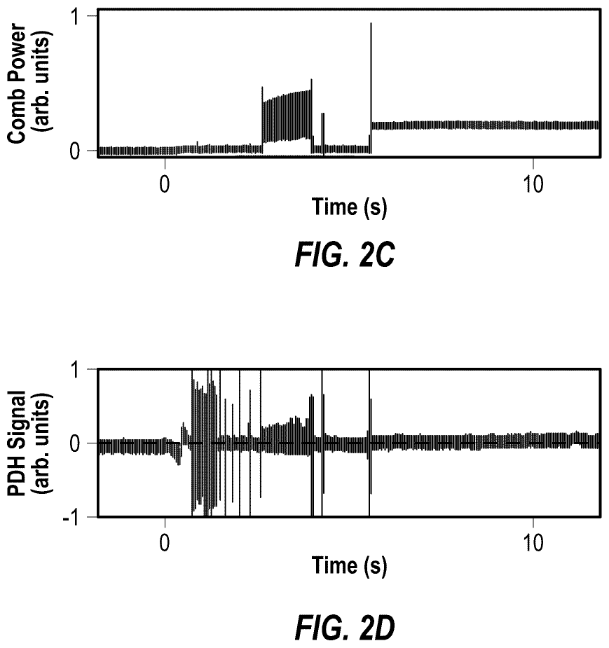

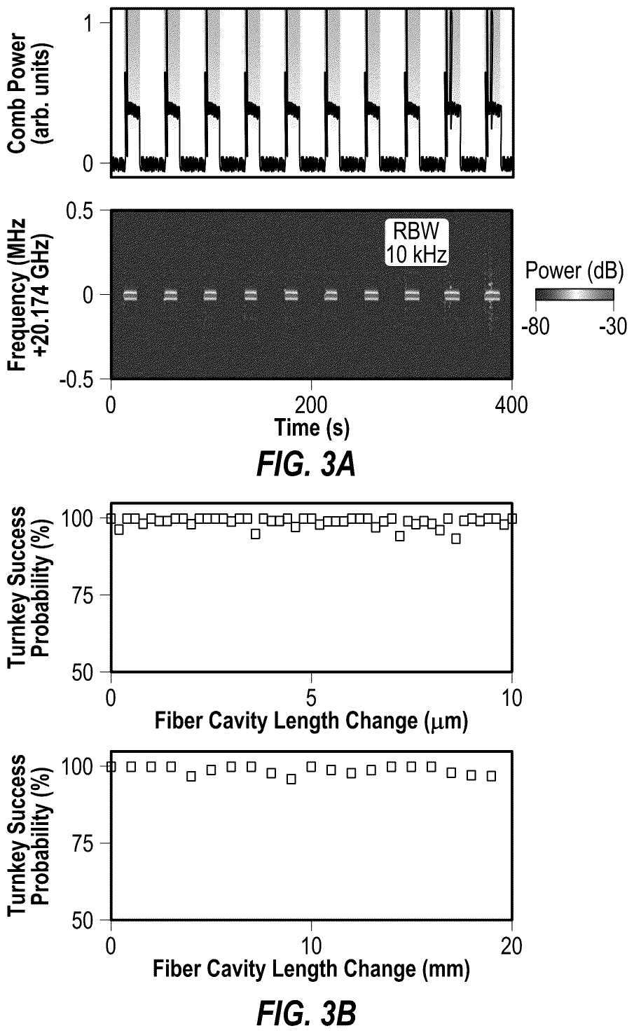

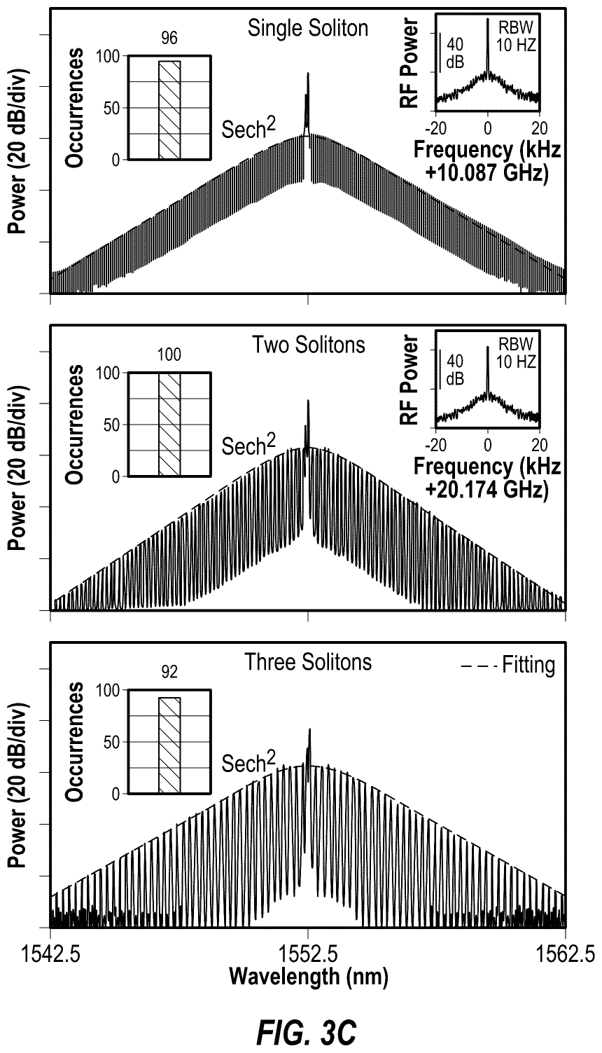

The temperature of the microresonator changes the offset frequency between the pump and Brillouin resonances. When the microresonator temperature is set such that this offset frequency is slightly smaller than the SBS frequency shift, then co-existing blue-detuned pump light and red-detuned SBL light in the microresonator manifests itself into a thermally stable DKS attractor (see FIG. 2A). The microresonator temperature is thus an effective control parameter that deterministically selects the DKS soliton number (see FIGS. 3A-3C).

FIG. 2A is a phase-space plot of SBL detuning (i.e., the difference between the SBL frequency, of the SBL light, and the center frequency of the Brillouin-mode resonance) versus pump detuning (i.e., the difference between the pump frequency and the center frequency of the pump-mode resonance) that illustrates the thermally stable DKS attractor. The DKS attractor is illustrated in FIG. 2A as a region of phase space bounded by a dashed box. The stable DKS attractor state is indicated by a the star symbol). This DKS attractor is defined by the intersection of a thermally stable pump-detuning regime (along the pump-detuning axis) and a SBL-detuning-controlled DKS regime (along the SBL-detuning axis). The soliton number is indicated by different shadings.

The left insert of FIG. 2A shows how at the DKS attractor state, the pump light is blue-detuned from the pump-mode resonance while the SBL light is red-detuned from the Brillouin-mode resonance. The dashed line in the insert represents the Brillouin gain spectrum. The right insert of FIG. 2A shows how at an intermediate unstable state, both the pump light and the SBL light are red-detuned from their respective resonances.

While the DKS attractor state is predominately determined by the microresonator, the turn-on dynamics closely follows the optical-pathlength change of the active ring cavity. This change in optical pathlength is caused by both an increase in the refractive index and thermal expansion of the ring cavity that results from absorption of the pump light outputted by the EDFA [40-42]. FIG. 2B is a plot of the pump-frequency red shift during the turn-on process, which serves as a spontaneous scan of pump detuning to drive the system into the DKS attractor state. FIGS. 2C and 2D show the synchronously measured evolution dynamics of comb power and pump Pound-Drever-Hall (PDH) signal, respectively. In FIG. 2D, a PDH signal greater than zero indicates blue detuning of the pump with respect to the pump-mode resonance, a PDH signal less than zero indicates red detuning of the pump with respect to the pump-mode resonance, and a PDH signal equal to zero indicates zero detuning of the pump with respect to the pump-mode resonance. As can be seen in FIGS. 2B-2D, after several oscillations a stable DKS frequency comb forms with the pump frequency clamped to the blue-detuned side of the pump-mode resonance.

### Phase-Independent Turnkey Brillouin-DKS Frequency-Comb Generation

To demonstrate repeatable turnkey operation, the 980-nm laser pumping the EDFA was modulated by a chopper with a square-wave profile to mimic the turn-on process. As shown in FIG. 3A, soliton microcomb operation is reliably achieved, as confirmed by synchronously monitoring the comb power (top) and the clean RF beat note of the comb repetition rate (bottom). In the top plot of FIG. 3A, the EDFA is operating (i.e., being pumped) in the shaded regions.

FIG. 3B are plots of turnkey success probability versus fine tuning of the microresonator cavity length (top) and coarse tuning of the microresonator cavity length (bottom). Each data point in both plots was acquired from 100 switch-on attempts. When the microresonator cavity length is either fine-tuned with a resolution of 0.2 μm across a range of 10 μm or coarse-tuned with a resolution of 1 mm across a range of 20 mm, a turnkey success probability close to 100% is achieved, indicating phase-independent and environment-insensitive turnkey operation which is user-friendly, in sharp contrast to NSIL-based microcombs [36-38].

FIG. 3C shows the optical spectra of a single-soliton state (top), a perfect soliton crystal (PSC) state with two solitons (middle), and a PSC state with three solitons (bottom), corresponding to repetition rates of 10.09 GHz, 20.18 GHz and 30.26 GHz, respectively. The dashed lines show the fitted soliton spectral envelopes. Besides these two-photon and three-photon PSC states, no other multi-soliton states were observed. The dominance of PSC states over other multi-soliton states is attributed to the equally spaced potential well created by co-lasing pump modes due to insufficient out-of-band suppression of the bandpass filter.

The right insets of FIG. 3C show RF beat notes of the comb repetition rate having high contrast and a single tone, a clear indication of stable mode-locking. Of note, the different soliton states were achieved by changing the microresonator temperature by ˜0.2 K, thus changing the final stable SBL detuning when the system reaches thermal equilibrium (see vertical axis of FIG. 2A). In addition, the left insets of FIG. 3C show how the system can robustly evolve into the same soliton states with a probability exceeding 90%, indicating a deterministic turnkey process.

### Immunity to Perturbations

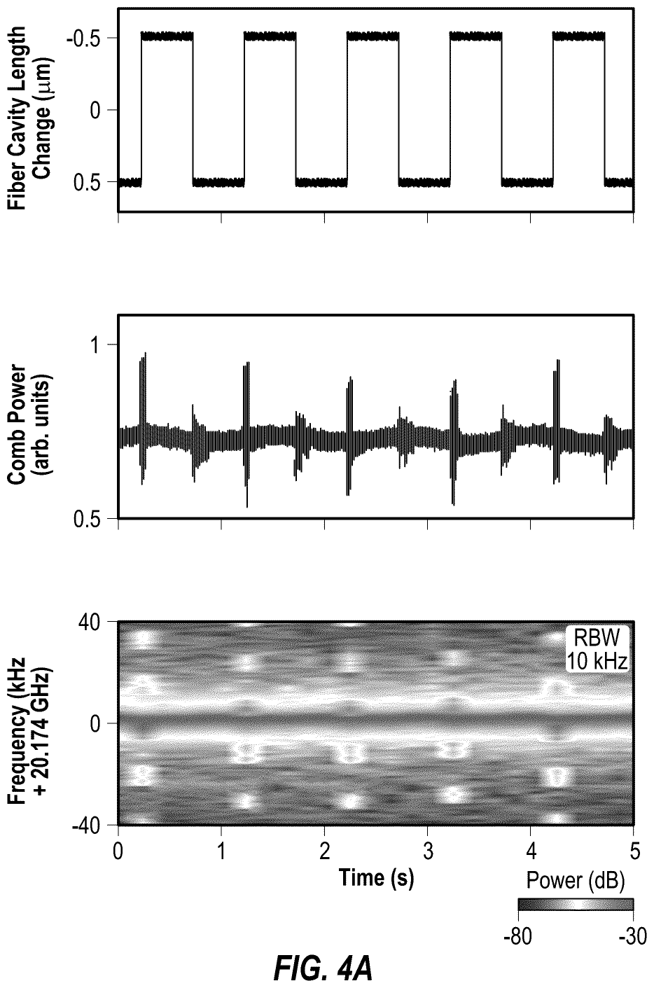

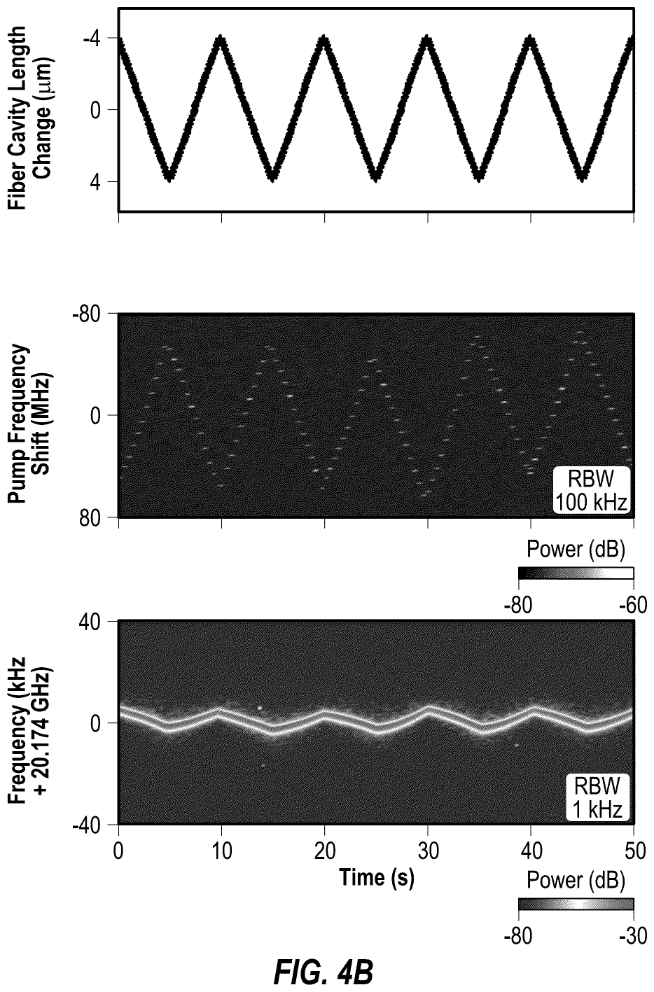

The microresonator-filtered laser is strongly immune to environmental perturbations, including changes in the microresonator cavity length, vibrations, and temperature fluctuations. FIG. 4A shows soliton self-healing for the two-soliton state of FIG. 3C. The microresonator cavity length was instantaneously changed by 1 μm (top). Both the comb power (middle) and soliton repetition rate (bottom) recover to the original state after the perturbation. As shown in FIG. 4B, the Brillouin-DKS frequency comb remains stable while the microresonator cavity length is slowly modulated by ±4 μm at a frequency of 0.1 Hz (top), corresponding to a change in repetition rate of ±4.5 kHz. At the same time, the pump frequency shifts by ±60 MHZ (middle) while the change in pump detuning is estimated to be ±100 kHz (bottom).

### Noise Performance

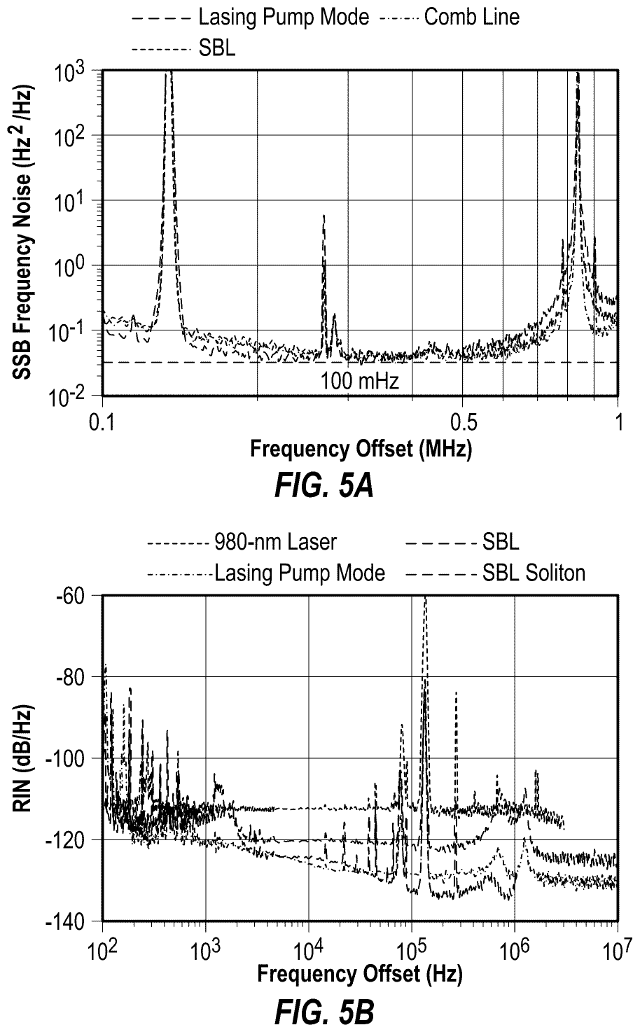

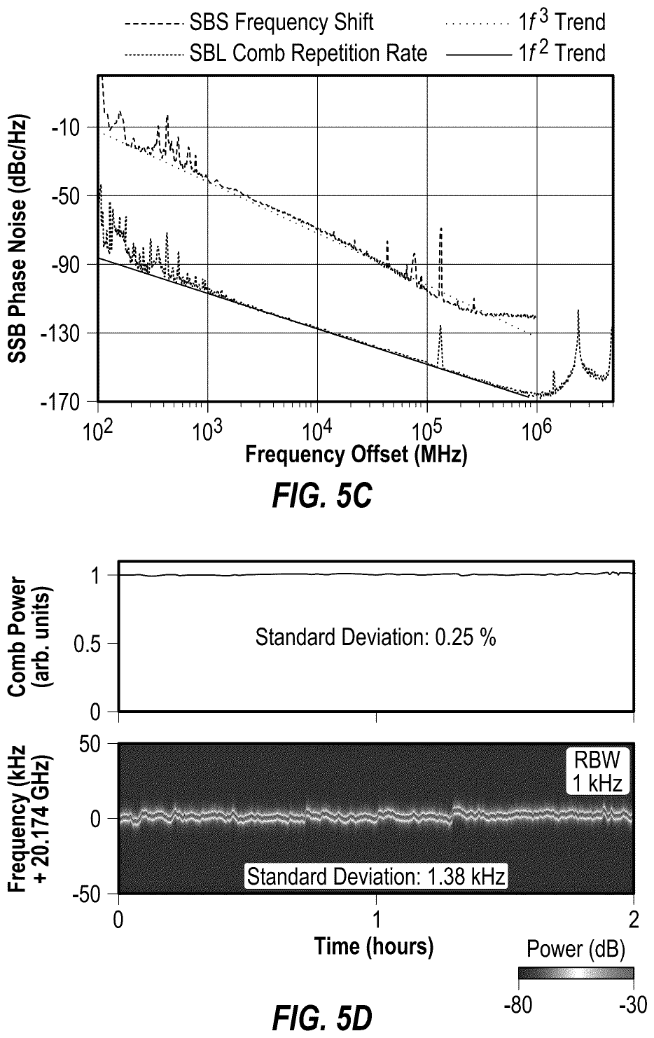

FIG. 5A is a plot of single-sideband (SSB) frequency noise of the intracavity pump light, the SBL light, and one of the Brillouin-DKS comb lines. Due to the ultrahigh Q of the MMF FP microresonator, the intracavity pump light, SBL light, and comb line all have a measured linewidth of ˜100 mHz. This record-breaking performance approaches that of on-chip SBL [44-46] but was achieved while the microresonator-filtered laser was free-running (i.e., without active stabilization). The measured linewidths were calculated from the white noise floor of the measured SSB frequency-noise spectra. The similarity of the measured linewidths is attributed to a weak linewidth narrowing factor of the SBS process. The magnitude of the measured linewidths is attributed to laser RIN.

FIG. 5B is a plot of relative intensity noise (RIN) of the 980-nm amplifier pump light, the intracavity pump light, the SBL light, and the SBL soliton. The measured RINs were all below −120 dB/Hz at offset frequencies above 1 kHz. The RIN of the 980-nm amplifier pump limits the frequency noise of the intracavity pump light and the SBL light (see FIG. 5A) due to conversion of amplitude noise into phase noise. Thus, lower frequency noise of the single-frequency pump and SBL could be obtained by reducing the RIN of the amplifier pump light.

A pump power of 180 mW was measured at Port 3 (see FIG. 1A). This high power was achieved due to non-critical coupling (see FIG. 1C) and a ˜70% external coupling efficiency. Due to the narrow linewidth of both the intracavity pump light and the SBL light, the SBS frequency shift at 10.347 GHz is a good frequency synthesizer with low SSB phase noise of −107 dBc/Hz at 100 kHz (see FIG. 5C). This phase-noise performance is comparable to one utilizing cascaded Brillouin processes [46, 47] but self-starts without pumping from a diode laser.

FIG. 5C is a plot of SSB phase noise of the SBS frequency shift (at 10.347 GHZ) and the comb repetition rate (at 10.087 GHZ), measured using an all-fiber reference-free Michelson interferometer (ARMI) setup that has an attosecond-level timing jitter resolution [8, 9, 48, 49]. This attosecond-level resolution exceeds the capability of direct photodetection methods [50-52]. The measured SSB phase noises at offset frequencies of 10 kHz, 100 kHz, and 1 MHZ are −128 dBc/Hz, −147 dBc/Hz, and −166 dBc/Hz, respectively. The timing jitter integrated from 18 kHz to 1 MHz is 1 fs, which is less than one-fifth of a single optical cycle at the SBL light and reaches the photonic-flywheel level. Compared with the soliton phase noise achieved with NSIL-based microcombs [38, 53, 54] and the phase noise of the SBS frequency shift, the phase noise of the comb repetition rate is not only an improvement of −10 dBc/Hz per decade, following the 1/f² trend with offset frequency, but also reaches a lower noise of −166 dBc/Hz at 1-MHz offset frequency. In FIG. 5C, the coherent artifacts at 2.5 MHz and its harmonics result from an 82-meter delay fiber in the ARMI setup. The peak at 135 kHz is due to RIN of the 980-nm pump.

FIG. 5D are plots of the comb power (top) and repetition rate (bottom), as measured over two hours in a laboratory environment with temperature variations of ±1 K. The standard deviations of the comb power and repetition rate for the two-soliton state were measured to be 0.25% and 1.38 kHz, respectively. The resolution bandwidth (RBW) of the repetition-rate measurements was 1 kHz. Also during the two-hour measurement, the pump frequency shift and pump detuning shift were measured to be 200 MHz and 70 kHz, respectively.

### MMF FP Microresonator

The high-Q MMF FP microresonator was fabricated through three steps. First, a commercial MMF (GIF50E, Thorlabs) was cleaved and encapsuled in a ceramic fiber ferrule. Second, both fiber ends were mechanically polished to sub-wavelength smoothness. Third, both fiber ends were coated with an optical dielectric Bragg mirror having a reflectivity over 99.9% from 1530 to 1570 nm. The large mode area of the MMF leads to low diffraction losses in the thick dielectric Bragg mirror coatings at both ends and results in ultrahigh Qs for both the internal pump mode and Brillouin mode [9].

The 10-mm long FP microresonator, corresponding to an optical path length (OPL) of ˜29 mm, results in a cold-cavity FSR of 10.087 GHZ, which is ready for microwave photonics applications. The group velocity dispersions of all the supported modes were simulated to be anomalous with ˜−28 fs²/mm [9].

### Details of Experimental Setup

The fiber cavity includes five meters of passive fiber and a free-space length of one meter, resulting in an OPL of 11.2 m and a FSR of 26.8 MHz. The home-made EDFA is bidirectionally pumped, having a 2-m erbium-doped fiber (SM-ESF-7/125, Nufern), two 980/1550-nm wavelength demultiplexers (WDMs) and two 980-nm diode lasers for each direction. The narrow BPF consists of a circulator and a temperature-controlled fiber Bragg grating centered at 1552.436 nm with a 3-dB bandwidth of 0.068 nm (8.5 GHZ). To achieve low coupling loss, free-space components were introduced to couple the light into and out from the MMF FP microresonator with one-end coupling efficiency of ˜70%. All-fiber integration is feasible due to the compatibility between the MMF FP microresonator and other fiber components. The EDFA and narrowband filter are shielded but not temperature controlled while the other components are exposed to the lab environment, including the 4-m passive fiber protected with 0.9-mm jacket. The optical circulator ensures the unidirectional lasing of the fiber cavity and couples out a portion of the high-power single-frequency pump laser. The polarization controller is used to maximize the coupling efficiency into the microresonator.

The Q of the Brillouin mode was not measured due to the difficulty of finding the high-order MMF mode and the low coupling efficiency between the single-mode fiber and MMF. However, we can still estimate its Q to be large than 1×10⁸ according to previous experimental data with a similar kind of large-mode-area FP microresonator [9]. In addition, the total input pump mode power before coupling into the microresonator is as low as ˜250 mW (at 980-nm total power of 1.5 W for the EDFA), also confirming the ultrahigh Q factor of the Brillouin mode. The MMF FP microresonator is temperature-controlled with a resolution of 10 mK.

A phase modulator is inserted in the active fiber ring cavity for all the experiments to monitor the pump detuning via the open-loop PDH error signal (see more details in Supplementary Information Section XII). The phase modulator is inserted before the BPF (see FIG. 1A). The modulation frequency is 1 MHz and the PDH signal is demodulated by the single-frequency pump laser output from the circulator. The low-pass filter used in the PDH signal demodulation is 100 kHz. The modulation voltage of the phase modulator is chosen to be low without perturbing the SBL soliton generation and turnkey operation. Since the PDH error signal measures the overall pump detuning, any resonance frequency shift induced by thermal and nonlinear effects will be captured in the PDH error signal.

The pump laser frequency shift is monitored by the beat note between the pump laser and a tunable ECDL that has a frequency stability of 2 MHz during the measurement. The beat note is measured by an electrical spectrum analyzer (E4407B, Keysight) at 4 Hz to show its evolution. The comb power is monitored by a filter centered at 1554.5 nm and having a 3-dB bandwidth of 0.5 nm. Fine tuning of the fiber cavity length at the micrometer level is realized by a piezoelectric stack, whose voltage-displacement curve is calibrated by a Mach-Zehnder interferometer (MZI).

We choose the 2-FSR perfect soliton crystal to characterize the turnkey soliton performance in FIGS. 3A-3C and 4A-4B for three reasons. First, it is easy to tell that the soliton energy source comes from the SBL instead of the pump laser according to the optical spectrum analyzer with a resolution of 0.02 nm. However, it is difficult to tell whether the DKS's pump is from the single-frequency pump or the SBL at the single-soliton state. Second, the 2-FSR perfect soliton crystal state can convincingly demonstrate the soliton generation with deterministic state for each turnkey operation when the system parameters are correctly set. Third, the 2-FSR perfect soliton crystal has a repetition rate of 20.18 GHz, which can be measured and processed by available electronics.

### Measurement of Laser Phase Noise and Fundamental Linewidth

A self-heterodyne frequency discriminator using a fiber based unbalanced MZI and a balanced photodetector (BPD) [9] is employed to measure the laser phase noise and fundamental linewidth. One arm of the unbalanced MZI is made of 250-m-long single-mode fiber, while the other arm had an acousto-optic frequency shifter with a frequency shift of 200 MHz and a polarization controller for high-voltage output. The FSR of the unbalanced MZI is 0.85 MHz. The two 50:50 outputs of the unbalanced MZI are connected to a BPD (PDB570C, Thorlabs) with a bandwidth of 400 MHz to reduce the impact of detector intensity fluctuations. The balanced output is then analyzed by a phase noise analyzer (NTS-1000A, RDL). The minimum fundamental linewidth that can be measured by this frequency discriminator is below 10 mHz.

### Measurement of Comb Repetition Rate Phase Noise and Timing Jitter

The RF beat note of the soliton repetition rate is directly detected by a fast photodetector (EOT, ET-3500F) and measured by an electrical spectrum analyzer (E4407B, Keysight) at 5 Hz to show its evolution. Since the soliton phase noise measurement is limited not only by the shot noise but also the available electronics operating at high frequency, the ARMI setup [8, 9, 48, 49] was introduced to precisely measure the phase noise of the SBL soliton. Two spectral regions of 1548.5±0.25 nm (3 dB) and 1556.5±0.25 nm (3 dB) are filtered out and sent to the interferometer. The locking bandwidth of the ARMI setup [9] is set to be 100 Hz. Therefore, the phase noise spectrum outside the locking bandwidth above 100 Hz is measured as shown in FIG. 5C.

The beat note of the SBS frequency shift (at 10.347 GHZ) was divided by a factor of 8 to 1.29 GHz. The phase noise of this 1.29-GHz signal was measured with a downconverter (DCR-2500A, RDL) and a phase noise analyzer (NTS-1000A, RDL).

### Effect of Microresonator Temperature on SBL Soliton Generation

FIG. 6 shows one example of how the MMF FP microresonator may be temperature controlled and stressed. The MMF FP microresonator is mounted in a ceramic sleeve that, in turn, is clamped in a metal mount. Only half of the mount may be temperature controlled through a thermoelectric cooler. For long-term operation, the microresonator temperature can slowly drift due to the changes in lab temperature. Two screws at the top of the metal mount may be used to stress the MMF FP microresonator to induce birefringence. Another type of actuator may be used instead of these screws (e.g., a micrometer or piezoelectric transducer).

### Chip-Based and Additional Embodiments

The microresonator-filtered laser (i.e., the ring laser 100 of FIG. 1A), with which pump generation in the ring cavity 104 and DKS generation in the resonator 120 are decoupled, is a universal topology for turnkey DKS generation and has the potential for full on-chip integration (e.g., as a photonic integrated circuit). For example, silicon-nitride Vernier microring filters have been proven effective as narrow on-chip bandpass filters [55]. Heterogeneously integrated semiconductor optical amplifiers (SOAs) [37] and erbium-doped silicon nitride waveguide amplifiers [56] have both been recently demonstrated as viable on-chip gain media. SBL generation has been achieved in a weakly-confined silicon nitride microresonator [46] and a recent study further shows the potential of a tightly-confined silicon nitride waveguide [57].

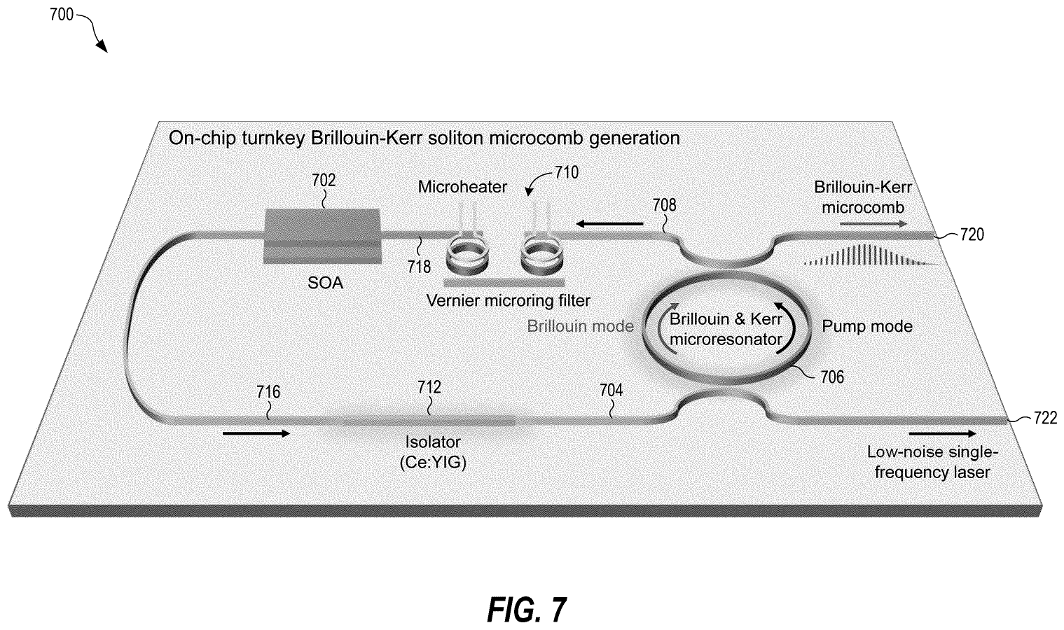

FIG. 7 is a perspective view of a photonic integrated circuit (PIC) 700 that is one example of a chip-based embodiment of the ring laser 100 of FIG. 1A. The PIC 700 includes an optical amplifier 702 that is one example of the optical amplifier 110 of FIG. 1A. In the example of FIG. 7, the optical amplifier 702 is shown as a semiconductor optical amplifier (SOA). However, the optical amplifier 702 may be another type of PIC-compatible optical amplifier.

The PIC 700 also includes a first bus waveguide 704 having an input end coupled to an output of the optical amplifier 702 to receive intracavity pump light (e.g., the intracavity pump light 106 of FIG. 1A) from the optical amplifier 702. The PIC 700 also includes a birefringent microresonator 706 positioned adjacent to the first bus waveguide 704 such that intracavity pump light propagating along the first bus waveguide 704 evanescently couples into the birefringent microresonator 706. The PIC 700 also includes a second bus waveguide 708 positioned adjacent to the birefringent microresonator 706 such that light in the birefringent microresonator 706 can evanescently couple into the second bus waveguide 708. The birefringent microresonator 706 is one example of the birefringent resonator 120 of FIG. 1A.

The PIC 700 also includes an optical bandpass filter 710 that is one example of the optical bandpass filter 140 of FIG. 1A. The optical bandpass filter 710 has an input coupled to a first end of the second bus waveguide 708. An output of the optical bandpass filter is coupled to an input of the optical amplifier 702 such that the optical amplifier 702, birefringent resonator 706, and optical bandpass filter 710 form a ring cavity (e.g., the ring cavity 104 of FIG. 1A). FIG. 7 shows the optical bandpass filter 710 as a Vernier microring filter that uses microheaters to tune the optical bandpass filter 710. However, the optical bandpass filter 710 may be implemented as another type of PIC-compatible optical bandpass filter.

The PIC 700 may include a third bus waveguide 718 coupling the output of the bandpass filter to the input of the optical amplifier. In some embodiments, and as shown in FIG. 7, the PIC 700 further includes an optical isolator 712 that serves the same function as the circulator 148 of FIG. 1A. Also in this embodiment, the PIC 700 includes a fourth bus waveguide 716 that couples an output of the optical amplifier 702 to an input of the optical isolator 712. While FIG. 7 shows the optical isolator 712 as being constructed from Ce: YIG, the optical isolator 712 may be alternatively constructed from another type of nonlinear optical crystal that is PIC compatible.

As shown in FIG. 7, a second end of the second bus waveguide 708 may serve as an output port 720 for a Brillouin-DKS microcomb generated by the birefringent microresonator 706. Similarly, a second end of the first bus waveguide 704 may be used as an output port 722 for the intracavity pump light. This output port is similar to PORT 3 in FIG. 1A.

In the example of FIG. 7, the birefringent microresonator 706 is shaped as a ring. The first bus waveguide 704 is positioned to evanescently couple intracavity pump light into the birefringent microresonator 706 at a first position of the birefringent microresonator 706. The second bus waveguide 708 is positioned to evanescently couple light (intracavity pump light, SBL light, and dissipative Kerr solitons) out of the birefringent microresonator 706 at a second position of the birefringent microresonator 706. The first and second positions may be antipodal points of the ring, as shown in FIG. 7, or other positions along the ring. The birefringent microresonator 706 may have a different shape (e.g., a stadium) without departing from the scope hereof.

The PIC 700 also illustrates that it is not necessary for the intracavity pump light and the SBL light (and therefore the dissipative Kerr solitons) to have different polarizations. More generally, when the intracavity pump light and SBL light are in two different modes, they can be spatially separated from each other. Spatially separating the SBL light from the intracavity pump light is important to prevent the larger ring cavity from lasing at the SBL-light frequency. In FIG. 7, the intracavity pump light propagates around the ring-shaped birefringent microresonator 706 in the counter-clockwise direction while the SBL light (and therefore the dissipative Kerr solitons) propagates around the birefringent microresonator 706 in the clockwise direction. In this case, the pump mode and Brillouin mode have different propagation directions and may be spatially separated from each other by how they couple into the second bus waveguide 708 (pump light propagates to the left toward the optical bandpass filter 710 while SBL light and dissipative Kerr solitons propagate to the right toward the output port 720).

In this example, the intracavity pump light and the SBL light may have the same polarization. Similarly, the intracavity pump light and the SBL light may excite the same transverse mode of the microresonator 706. If this same transverse mode is the fundamental transverse mode, then the microresonator 706 may be a single mode resonator. Alternatively, the intracavity pump light and the SBL light may excite different transverse modes of the microresonator 706, in which case the microresonator 706 may be a multimode resonator (e.g., the MMF FP microresonator of FIG. 1B). This example also shows that the birefringent resonator 120 of FIG. 1A does not need to be a Fabry-Perot resonator, but may alternatively be a ring resonator.

Similarly, the ring laser 100 of FIG. 1A may operate with the intracavity pump light 106 and SBL light having the same linear polarization. As shown at the top right of FIG. 1A, the pump light 106 and SBL light excite different transverse modes of the MMF FP resonator. Instead of the polarizing beamsplitter 130 (and polarization rotator 138), a spatial mode separator may be used to spatially separate the pump light 106 and SBL light from each other. The pump light 106, after separating, is then coupled back into the ring cavity 104 while the SBL light (and dissipative Kerr solitons) is coupled out of the ring cavity 104.

SBS is not the only intracavity effect that can be used to implement the two-step pumping scheme. Avoided mode crossings (AMXs) [58-61] may alternatively be utilized and it relaxes the need to match the microresonator FSR with the SBS frequency shift, rendering AMXs more flexible and user-friendly for on-chip, turnkey DKS microcomb generation.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

### REFERENCES

[1] T. J. Kippenberg, A. L. Gacta, M. Lipson, and M. L. Gorodetsky, “Dissipative Kerr solitons in optical microresonators,” Science 361, caan8083 (2018).
[2] A. L. Gacta, M. Lipson, and T. J. Kippenberg, “Photonic-chip-based frequency combs,” Nat. Photonics 13, 158-169 (2019).
[3] J. Pfeifle et al., “Coherent terabit communications with microresonator Kerr frequency combs,” Nat. Photonics 8, 375-380 (2014).
[4] A. Jørgensen et al., “Petabit-per-second data transmission using a chip-scale microcomb ring resonator source,” Nat. Photonics 16, 798-802 (2022).
[5] J. Riemensberger et al., “Massively parallel coherent laser ranging using a soliton microcomb,” Nature 581, 164-170 (2020).
[6] C. Bao et al., “Architecture for microcomb-based GHz-mid-infrared dual-comb spectroscopy,” Nat. Commun. 12, 6573 (2021).
[7] A. J. Benedick, J. G. Fujimoto, and F. X. Kärtner, “Optical flywheels with attosecond jitter,” Nat. Photonics 6, 97-100 (2012).
[8] K. Jia et al., “Photonic flywheel in a monolithic fiber resonator,” Phys. Rev. Lett. 125, 143902 (2020).
[9] M. Nie et al., “Synthesized spatiotemporal mode-locking and photonic flywheel in multimode mesoresonators,” Nat. Commun 13, 6395 (2022).
[10] P. Ghelfi et al., “A fully photonics-based coherent radar system,” Nature 507, 341-345 (2014).
[11] A. Khilo et al., “Photonic ADC: overcoming the bottleneck of electronic jitter,” Opt. Express 20, 4454-4469 (2012).
[12] A. Mahjoubfar et al., “Time stretch and its applications,” Nat. Photonics. 11, 341-351 (2017).
[13] Y. Na et al., “Ultrafast, sub-nanometre-precision and multifunctional time-of-flight detection,” Nat. Photonics 14, 355-360 (2020).
[14] Y.-S. Jang et al., “Nanometric precision distance metrology via hybrid spectrally resolved and homodyne interferometry in a single soliton frequency microcomb,” Phys. Rev. Lett. 126, 023903 (2021).
[15] S.-W. Huang et al., “High-energy pulse synthesis with sub-cycle waveform control for strong-field physics,” Nat. Photonics. 5, 475-479 (2011).
[16] C. Manzoni et al., “Coherent pulse synthesis: towards sub-cycle optical waveforms,” Laser Photonics Rev. 9, 129-171 (2015).
[17] P. Krogen et al., “Generation and multi-octave shaping of mid-infrared intense single-cycle pulses,” Nat. Photonics. 11, 222-226 (2017).
[18] M. Xin et al., “Attosecond precision multi-kilometer laser-microwave network,” Light Sci. Appl. 6, e16187-e16187 (2017).
[19] X. Chen, et al., “High-precision multi-node clock network distribution,” Rev. Sci. Instrum. 88, 103103 (2017).
[20] M. Xin, K. Şafak, and F. X. Kärtner, “Ultra-precise timing and synchronization for large-scale scientific instruments,” Optica 5, 1564-1578 (2018).
[21] C. Grebing et al., “Realization of a timescale with an accurate optical lattice clock,” Optica 3, 563-569 (2016).
[22] L. C. Sinclair, H. Bergeron, W. C. Swann, E. Baumann, J.-D. Deschênes, and N. R. Newbury, “Comparing Optical Oscillators across the Air to Milliradians in Phase and 10⁻¹⁷ in Frequency,” Phys. Rev. Lett. 120, 050801 (2018).
[23] A. B. Matsko and L. Maleki, “On timing jitter of mode locked Kerr frequency combs,” Opt. Express 21, 28862-28876 (2013).
[24] Y. Bai et al., “Brillouin-Kerr soliton frequency combs in an optical microresonator,” Phys. Rev. Lett. 126, 063901 (2021).
[25] I. H. Do et al., Self-stabilized soliton generation in a microresonator through mode-pulled Brillouin lasing, Opt. Lett. 46, 1772-1775 (2021).
[26] H. Zhang et al., “Soliton Microcombs Multiplexing Using Intracavity-Stimulated Brillouin Lasers,” Phys. Rev. Lett. 130, 153802 (2023).
[27] M. Peccianti et al., “Demonstration of a stable ultrafast laser based on a nonlinear microcavity,” Nat. Commun. 3, 765 (2012).
[28] A. Pasquazi et al., “Self-locked optical parametric oscillation in a CMOS compatible microring resonator: a route to robust optical frequency comb generation on a chip,” Opt. Express 21, 13333-13341 (2013).
[29] C. Reimer et al., “Cross-polarized photon-pair generation and bi-chromatically pumped optical parametric oscillation on a chip,” Nat. Commun. 6, 8236 (2015).
[30] W. Wang et al., “Self-locked orthogonal polarized dual comb in a microresonator,” Photonics Res. 6, 363-367 (2018).
[31] M. Rowley et al., “Thermo-optical pulsing in a microresonator filtered fiber-laser: a route towards all-optical control and synchronization,” Opt. Express. 27, 19242-19254 (2019). H. Bao et al., “Laser cavity-soliton microcombs,” Nat. Photonics. 13, 384-389 (2019).
[33] M. Rowley et al., “Self-emergence of robust solitons in a microcavity,” Nature 608, 303-309 (2022).
[34] A. Cutrona et al., “Stability of laser cavity-solitons for metrological applications,” Appl. Phys. Lett. 122, 121104 (2023).
[35] M. Nie et al., “Dissipative soliton generation and real-time dynamics in microresonator-filtered fiber lasers,” Light Sci. Appl. 11, 296 (2022).
[36] B. Shen et al., “Integrated turnkey soliton microcombs,” Nature 582, 365-369 (2020).
[37] C. Xiang et al., “Laser soliton microcombs heterogeneously integrated on silicon,” Science 373, 99-103 (2021).
[38] A. S. Voloshin et al., “Dynamics of soliton self-injection locking in optical microresonators,” Nat. Commun. 12, 235 (2021).
[39] L. G. Wright et al., “Mechanisms of spatiotemporal mode-locking,” Nat. Phys. 16, 565-570 (2020).
[40] Y. O. Barmenkov, A. V. Kir'yanov, and M. V. Andrés, “Resonant and thermal changes of refractive index in a heavily doped erbium fiber pumped at wavelength 980 nm,” Appl. Phys. Lett. 85, 2466-2468 (2004).
[41] M. Janos and S. C. Guy, “Signal-induced refractive index changes in erbium-doped fiber amplifiers,” J. Light. Technol. 16, 542 (1998).
[42] C. Thirstrup, Y. Shi, and B. Palsdottir, “Pump-induced refractive index modulation and dispersions in Er³⁺-doped fibers,” J. Light. Technol. 14, 732-738 (1996).
[43] Z. Lu et al., “Synthesized soliton crystals,” Nat. Commun. 12, 3179 (2021).
[44] J. Li, H. Lee, T. Chen, and K. J. Vahala, “Characterization of a high coherence, Brillouin microcavity laser on silicon,” Opt. Express. 20, 20170-20180 (2012).
[45] W. Loh et al., “A microrod-resonator Brillouin laser with 240 Hz absolute linewidth,” New J. Phys. 18, 045001 (2016).
[46] S. Gundavarapu et al., “Sub-hertz fundamental linewidth photonic integrated Brillouin laser,” Nat. Photonics. 13, 60-67 (2019).
[47] J. Li, H. Lee, and K. J. Vahala, “Microwave synthesizer using an on-chip Brillouin oscillator,” Nat. Commun. 4, 2097 (2013).
[48] D. Kwon et al., “Reference-free, high-resolution measurement method of timing jitter spectra of optical frequency combs,” Sci. Rep. 7, 40917 (2017).
[49] D. Jeong et al., “Ultralow jitter silica microcomb,” Optica 7, 1108-1111 (2020).
[50] E. Lucas et al., “Ultralow-noise photonic microwave synthesis using a soliton microcomb-based transfer oscillator,” Nat. Commun. 11, 374 (2020).
[51] S.-W. Huang et al., “A low-phase-noise 18 GHz Kerr frequency microcomb phase-locked over 65 THz,” Sci. Rep. 5, 13355 (2015).
[52] J. R. Stone et al., “Thermal and nonlinear dissipative-soliton dynamics in Kerr-microresonator frequency combs,” Phys. Rev. Lett. 121, 063902 (2018).
[53] W. Liang et al., “High spectral purity Kerr frequency comb radio frequency photonic oscillator,” Nat. Commun. 6, 7957 (2015).
[54] W. Jin et al., “Hertz-linewidth semiconductor lasers using CMOS-ready ultra-high-Q microresonators,” Nat. Photonics. 15 (2021) 346-353.
[55] B. Stern et al., “Battery-operated integrated frequency comb generator,” Nature 562, 401-405 (2018).
[56] Y. Liu et al., “A photonic integrated circuit-based erbium-doped amplifier,” Science 376, 1309-1313 (2022).
[57] F. Gyger et al., “Observation of stimulated Brillouin scattering in silicon nitride integrated waveguides,” Phys. Rev. Lett. 124, 013902 (2020).
[58] B. Y. Kim et al., “Turn-key, high-efficiency Kerr comb source,” Opt. Lett. 44, 4475-4478 (2019).
[59] H. Weng et al., “Directly accessing octave-spanning dissipative Kerr soliton frequency combs in an AlN microresonator,” Photonics Res. 9, 1351-1357 (2021).
[60] D. Grassani et al., “Extending thermal stability of short-living soliton states in silicon nitride microring resonators,” Opt. Continuum 1, 1516-1528 (2022).
[61] H. Shu et al., “Submilliwatt, widely tunable coherent microcomb generation with feedback-free operation,” Adv. Photonics. 5, 036007-036007 (2023).

What is claimed is:

1. A ring laser, comprising:
an optical amplifier, a birefringent resonator, a polarizing beamsplitter, and a bandpass filter forming a ring cavity;
wherein:
the birefringent resonator has a first series of resonances and a second series of resonances, the first series of resonances corresponding to a first linear polarization, the second series of resonances corresponding to a second linear polarization that is orthogonal to the first linear polarization;
the polarizing beamsplitter has a first output port and a second output port, the first output port being configured to transmit intracavity light having the first linear polarization into the ring cavity, the second output port being configured to transmit intracavity light having the second linear polarization out of the ring cavity;
the ring laser is configured to generate intracavity pump light having the first linear polarization;
the birefringent resonator is configured to generate stimulated Brillouin laser (SBL) light in response to the intracavity pump light coupling to a first resonance of the first series of resonances, the SBL light having the second linear polarization; and
the birefringent resonator is configured to generate a dissipative-Kerr-soliton (DKS) frequency comb in response to the SBL light coupling to a second resonance of the second series of resonances, the DKS frequency comb having the second linear polarization.

2. The ring laser of claim 1, wherein:
the intracavity pump light has a pump frequency;
the stimulated Brillouin light has a Brillouin frequency that is shifted from the pump frequency by a frequency shift; and
an offset frequency between the first resonance and the second resonance is less than the frequency shift.

3. The ring laser of claim 1, the birefringent resonator comprising a Fabry-Perot resonator.

4. The ring laser of claim 3, the Fabry-Perot resonator comprising a segment of multimode optical fiber.

5. The ring laser of claim 1, further comprising a thermoelectric cooler in thermal contact with the birefringent resonator.

6. The ring laser of claim 1, the birefringent resonator having a free spectral range of 1 GHz or more.

7. The ring laser of claim 1, the bandpass filter having a bandwidth that is less than a free spectral range of the birefringent resonator.

8. The ring laser of claim 1, the ring cavity having a free spectral range that is larger than a linewidth of the birefringent resonator.

9. The ring laser of claim 1, further comprising a resonator mount within which the birefringent resonator is mounted, the resonator mount comprising at least one actuator that, when adjusted, changes a stress applied to the birefringent resonator.

10. The ring laser of claim 1, wherein each first resonance, of the first series of resonances, has a nearest second resonance, of the second series of resonance, such that the nearest second resonance is red-shifted with respect to said each first resonance.

11. The ring laser of claim 1, wherein the birefringent resonator has a Brillouin gain bandwidth that is greater than a linewidth of the birefringent resonator.

12. The ring laser of claim 1, wherein the birefringent resonator has a Brillouin gain bandwidth that is less than a free spectral range of the birefringent resonator.

13. The ring laser of claim 1, implemented at least in part as a photonic integrated circuit.

14. A method for frequency-comb generation, comprising:
operating the ring laser of claim 1 to generate the DKS frequency comb; and
coupling the DKS frequency comb out of the ring cavity via the second output port of the polarizing beamsplitter.

15. The method of claim 14, wherein said operating the ring laser comprises:
generating, with the ring laser, the intracavity pump light;
pumping the birefringent resonator of the ring laser with the intracavity pump light to generate the SBL light; and
pumping the birefringent resonator with the SBL light to generate the DKS frequency comb.

16. The method of claim 14, further comprising controlling the birefringent resonator to change an offset frequency between the first resonance and the second resonance.

17. The method of claim 16, wherein said controlling the birefringent resonator comprises positioning the second resonance such that a red side of the second resonance overlaps a blue side of a stimulated Brillouin gain spectrum of the birefringent resonator.

18. The method of claim 14, further comprising sweeping a frequency of the pump light from a blue side of the first resonance toward a center of the first resonance such that said sweeping increases stimulated Brillouin scattering of the pump light into the SBL light.

19. The method of claim 18, wherein:
said sweeping causes a frequency of the SBL light to sweep across the second resonance; and
a red side of the second resonance overlaps a blue side of a stimulated Brillouin gain spectrum of the birefringent resonator.

20. The method of claim 19, wherein after said sweeping, the SBL light has a frequency that overlaps both a red side of the second resonance and the blue side of the stimulated Brillouin gain spectrum.
